(19) United States
(12) Patent Application Publication
(10) Pub. No.: US 2007/0238024 A1
(43) Pub. Date: Oct. 11, 2007

(54) Alkaline battery

(76) Inventors: Takashi Mushiga, Osaka (JP); Kenji Yamamoto, Osaka (JP); Hirofumi Iwaki, Osaka (JP)

Correspondence Address: MCDERMOTT WILL & EMERY LLP, 600 13TH STREET, NW, WASHINGTON, DC, 20005-3096, US

(21) Appl. No.: 11/727,210

(22) Filed: Mar. 23, 2007

Related U.S. Application Data
(60) Provisional application No. 60/849,484, filed on Oct. 5, 2006.

(30) Foreign Application Priority Data
Mar. 24, 2006 (JP) 2006-083298

(51) Int. Cl. H01M 4/62; H01M 4/50

(52) U.S. Cl. 429/232; 429/224

(57) ABSTRACT

An alkaline battery excellent in reliability, capable of surely suppressing an internal short circuit due to the growth of a dendritic crystal of zinc oxide, even when the amount of sodium remaining in an electrolytic manganese dioxide powder used for a positive electrode active material is large is provided. The alkaline battery has a positive electrode containing electrolytic manganese dioxide, a negative electrode containing zinc or a zinc alloy, a separator arranged between the positive electrode and the negative electrode, and an alkaline electrolytic solution, the alkaline battery being characterized in that the positive electrode contains 0.1 to 0.7 parts by weight of sodium per 100 parts by weight of electrolytic manganese dioxide, and 0.003 to 0.05 parts by weight of silicon per 100 parts by weight of electrolytic manganese dioxide.

### FIELD OF THE INVENTION

The present invention relates to an alkaline battery, and more particularly to a positive electrode of the alkaline battery.

### BACKGROUND OF THE INVENTION

Generally, an alkaline battery has a structure in which a cylindrical positive electrode mixture is arranged in a positive electrode case serving as a positive electrode terminal so as to contact closely with the positive electrode case, and a gel negative electrode is arranged in the center of the cylindrical positive electrode mixture via a separator. Further, electrolytic manganese dioxide is generally used for a positive electrode active material contained in the positive electrode mixture.

The above described electrolytic manganese dioxide is produced as follows. That is, a deposit of electrolytic manganese dioxide is obtained on an anode by conducting electrolysis in an electrolytic cell containing a manganese sulfate solution. The deposit of electrolytic manganese dioxide is peeled to be coarsely powdered, and then cleaned and dried. Thereafter, the particle diameter of the above described deposit is adjusted by grinding, so that an electrolytic manganese dioxide powder is obtained. Further, the above described powder is cleaned and neutralized in order to remove sulfuric acid remaining in the powder, and thereafter dried. As a result, an electrolytic manganese dioxide powder is eventually obtained.

For the above described neutralizing agent, for example, a sodium hydroxide aqueous solution and a sodium hydrogencarbonate aqueous solution are used. For this reason, the sodium contained in the neutralizing agent used in the neutralization process remains in the electrolytic manganese dioxide powder. In the case where the amount of the residual sodium is large, a dendritic crystal of zinc oxide grows in the negative electrode thereby penetrating the separator. As such, the dendritic crystal may be brought into contact with the positive electrode so as to form an internal short circuit.

A method for preventing the internal short circuit caused by the residual sodium involves cleaning the electrolytic manganese dioxide powder while being heated and pressurized with steam at 100 to 250° C. in a pressure vessel.

However, since the neutralization process using the neutralizing agent containing sodium is not included in the above described manufacturing process of electrolytic manganese dioxide powder, an electrolytic manganese dioxide powder having a low pH is obtained. If an electrolytic manganese dioxide powder having a low pH is used in the manufacturing process of the positive electrode mixture, a metal mold used for molding the positive electrode mixture is easily corroded, and thereby problems in the manufacturing process may take place. In addition, the metal mold needs to be frequently replaced with a new one, resulting in an increase in the manufacturing cost.

Further, a method for preventing the internal short circuit due to the growth of the dendritic crystal of zinc oxide in the negative electrode involves adding silicon to the negative electrode. Another method involves having silicon contained in the electrolytic solution held in the separator. However, when the content of sodium in the electrolytic manganese dioxide powder is increased, it is difficult to prevent internal short circuits, which remains a problem to be improved.

### BRIEF SUMMARY OF THE INVENTION

Accordingly, an one aspect of the invention is to provide an alkaline battery excellent in reliability, capable of suppressing the internal short circuit due to the growth of the dendritic crystal of zinc oxide, even when the amount of sodium remaining in the electrolytic manganese dioxide powder used for the positive electrode active material is large.

An alkaline battery in accordance with an aspect of the invention, having a positive electrode containing electrolytic manganese dioxide, a negative electrode containing zinc or a zinc alloy, a separator arranged between the positive electrode and the negative electrode, and an alkaline electrolytic solution, is characterized in that the positive electrode contains 0.1 to 0.7 parts by weight of sodium per 100 parts by weight of electrolytic manganese dioxide, and 0.003 to 0.05 parts by weight of silicon per 100 parts by weight of electrolytic manganese dioxide.

In another aspect of the invention, the thickness of the separator is 150 to 300 μm. It is also preferred that the alkaline electrolytic solution is a potassium hydroxide aqueous solution having a concentration of 33 to 40% by weight.

Note that in the positive electrode, sodium exists, for example, as a salt such as sodium sulfate, a hydroxide or an oxide, and silicon exists, for example, as an oxide such as SiO₂. Further, sodium may be contained, for example, in the above described electrolytic manganese dioxide.

In another aspect of the invention, the zinc or the zinc alloy powder has a median diameter of 110 to 200 μm.

In another aspect of the invention, an AA size alkaline battery has a positive electrode comprising a positive electrode mixture comprising electrolytic manganese dioxide, a negative electrode comprising zinc or a zinc alloy, a separator arranged between the positive electrode and the negative electrode, and an alkaline electrolytic solution. The battery has a capacity above 0.9 V closed circuit voltage of at least 37.7 min/g of electrolytic manganese dioxide when the battery is subjected to a sequential discharge regimen at 20° C. as follows:

a) discharge under a 3.3Ω load for 4 minutes,

b) disconnect the load for 56 minutes,

c) repeat a) and b) for an additional 7 cycles,

d) stand at open circuit for 16 hours, and

e) repeat a) through d).

In another aspect of the invention, an AA size alkaline battery has a positive electrode comprising a positive electrode mixture comprising electrolytic manganese dioxide, a negative electrode comprising zinc or a zinc alloy, a separator arranged between the positive electrode and the negative electrode, and an alkaline electrolytic solution. The battery has a capacity above 0.9 V close circuit voltage of at least 0.20 Ahr/g of positive electrode mixture when the battery is subjected to a sequential discharge regimen at 20° C. as follows:

a) discharge under a 3.3Ω load for 4 minutes,

b) disconnect the load for 56 minutes,

c) repeat steps a) and b) for an additional 7 cycles,

d) stand at open circuit for 16 hours, and

e) repeat steps a) through d).

According to an aspect of the invention, it is possible to provide an alkaline battery excellent in reliability, capable of suppressing the internal short circuit due to the growth of the dendritic crystal of zinc oxide, even when the amount of sodium remaining in the electrolytic manganese dioxide powder used for the positive electrode active material is large.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a partial sectional front view of an alkaline primary battery according to an aspect of the invention.

FIG. 2 illustrates discharge curves of prior art batteries and batteries according to an aspect of the invention.

### DETAILED DESCRIPTION OF THE INVENTION

An aspect of the invention relates to an alkaline battery having a positive electrode containing electrolytic manganese dioxide, a negative electrode containing zinc or a zinc alloy, a separator arranged between the positive electrode and the negative electrode, and an alkaline electrolytic solution, the alkaline battery being characterized in that the positive electrode contains 0.1 to 0.7 parts by weight of sodium per 100 parts by weight of electrolytic manganese dioxide, and 0.003 to 0.05 parts by weight of silicon per 100 parts by weight of electrolytic manganese dioxide.

In a conventional alkaline battery using a positive electrode not containing silicon, when the sodium content in the positive electrode is increased to about 0.1 parts by weight per 100 parts by weight of electrolytic manganese dioxide, an internal short circuit may be caused by the growth of a dendritic crystal of zinc oxide. On the other hand, in the present invention, silicon is arranged to be contained in the positive electrode in the above described range. For this reason, even if the sodium content in the positive electrode is as large as 0.1 to 0.7 parts by weight per 100 parts by weight of electrolytic manganese dioxide, in comparison with the prior art, it is possible to suppress the internal short circuit due to the growth of the dendritic crystal of zinc oxide, to thereby obtain an alkaline battery excellent in reliability.

Although the detailed mechanism is not clear, in the case where silicon is present in the vicinity of zinc or zinc-alloy particles, the internal short circuit due to the crystal growth of zinc oxide formed by the battery reaction can be prevented. On the other hand, in this case, the amount of gas generated at the time of over-discharge is increased, which may cause liquid leakage. For this reason, by making silicon contained in the positive electrode rather than in the negative electrode or the separator, it is possible to suppress internal short circuits, and to reduce the amount of gas generated at the time of over-discharge.

In the case where the sodium content in the positive electrode is less than 0.1 parts by weight per 100 parts by weight of electrolytic manganese dioxide, the electrolytic manganese dioxide powder has a low pH to thereby cause a metal mold for molding the positive electrode mixture to be corroded. As a result, a problem that the positive electrode mixture cannot be filled in a battery of a predetermined weight and size, or the like, tends to occur. In the case where the sodium content in the positive electrode exceeds 0.7 parts by weight per 100 parts by weight of electrolytic manganese dioxide, dendritic crystals grow in the negative electrode, which may cause an internal short circuit. Further, it is preferred that the positive electrode contains 0.2 to 0.5 parts by weight of sodium per 100 parts by weight of electrolytic manganese dioxide.

Further, in the case where the silicon content in the positive electrode is less than 0.003 parts by weight per 100 parts by weight of electrolytic manganese dioxide, the effect of suppressing the growth of dendritic crystals in the negative electrode is reduced so that internal short circuits tend to be caused. In the case where the silicon content in the positive electrode exceeds 0.05 parts by weight per 100 parts by weight of electrolytic manganese dioxide, the amount of positive electrode active material is reduced so that the discharge performance is deteriorated. In the case where the silicon content in the positive electrode is not less than 0.005 parts by weight per 100 parts by weight of electrolytic manganese dioxide, it is possible to more surely suppress the growth of the dendritic crystal in the negative electrode, to thereby prevent internal short circuits.

The silicon content in the positive electrode is 0.01 to 0.02 parts by weight per 100 parts by weight of electrolytic manganese dioxide.

An example of a method for manufacturing the electrolytic manganese dioxide powder will be described in the following.

A deposit of electrolytic manganese dioxide is obtained on an anode (for example, having a plate-like shape) by conducting electrolysis in an electrolytic cell containing a manganese sulfate solution. The obtained deposit is peeled to be coarsely powdered, and then cleaned and dried. Thereafter, the particle diameter of the deposit is adjusted by grinding, so that an electrolytic manganese dioxide powder is obtained. Then, the electrolytic manganese dioxide powder is further treated in a cleaning process, a neutralization process, and a drying process in order to remove sulfuric acid remaining in the electrolytic manganese dioxide powder, so that an electrolytic manganese dioxide powder for the positive electrode active material is eventually obtained. The average particle diameter of the obtained electrolytic manganese dioxide powder is, for example, 25 to 70 μm.

For a neutralizing agent used in the neutralization process, for example, a sodium hydroxide aqueous solution and a sodium hydrogencarbonate aqueous solution are used. The sodium in the positive electrode results from the neutralizing agent remaining in the electrolytic manganese dioxide powder, which neutralizing agent is used in the neutralization process in manufacturing the electrolytic manganese dioxide powder and contains sodium. The amount of sodium in the positive electrode can be adjusted by changing, for example, the amount and concentration of the neutralizing agent, the neutralization time, or the like.

The amount of sodium in the positive electrode can be measured, for example, by an atomic absorption photometric method.

The positive electrode according to an aspect of the invention contains silicon. Such positive electrode can be obtained by mixing an electrolytic manganese dioxide powder with a silicon powder or a powder of oxide containing silicon, such as SiO₂, when the positive electrode is produced. That is, for the positive electrode, it is possible to use a positive electrode mixture obtained by molding a mixture material to form a predetermined shape, which mixture material is obtained by mixing, for example, an electrolytic manganese dioxide powder containing sodium, a silicon powder or a powder of compound containing silicon such as SiO₂, a graphite powder as the conductive agent, and an alkaline electrolytic solution.

The electrolytic manganese dioxide powder has a higher pH as it contains more sodium. As a result, the corrosion of the metal mold used in the process for molding the positive electrode mixture is suppressed to thereby prevent trouble in the manufacturing process caused by the corrosion of the metal mold. Further, the increase in the manufacturing cost caused by frequently replacing the metal mold with a new one, can be suppressed.

For the negative electrode, it is possible to use a gel negative electrode obtained by using a mixture which is obtained by mixing, for example, a powder of zinc or a zinc alloy as the negative electrode active material, sodium polyacrylate as the gelling agent, and an alkaline electrolytic solution. As the negative electrode active material, a powder of zinc or a powder of a zinc alloy may also be used. Further, as the zinc alloy, a zinc alloy which contains zinc and at least one of bismuth, aluminum, calcium, indium, or the like, may be used.

In an aspect of the invention, the zinc or zinc alloy powder has a median diameter of 110 to 200 μm. Although the mechanism is not known, the inventors have found that as the particles of the zinc or the zinc alloy are finer (the surface area is increased), the abnormal discharge due to the internal short circuit can be suppressed even by a small amount of silicon. It is inferred that this is because as the particles of the zinc or the zinc alloy are finer and thereby the surface area is increased, the load per unit area is reduced to make the oxidation reaction of zinc at the time of discharge tend to proceed more uniformly, thereby preventing remarkable growth of a dendritic crystal of zinc oxide in a specific part.

If the median powder diameter is 110 μm or more, the viscosity of the gel negative electrode is not excessively high, and hence, the gel negative electrode can be easily filled at the time of assembling an alkaline battery.

Note that the median diameter can be obtained by measuring the volumetric particle size distribution of the powder of the zinc or the zinc alloy. The volumetric particle size distribution can be measured by using the laser diffraction type HELOS & RODOS made by SYMPATEC company, and by setting, for example, the dispersion pressure at 2.0 bar and the use range at R6.

As the negative electrode active material, it is possible to use, for example, a powder of zinc alloy which contains 30 ppm of aluminum, 200 ppm of bismuth and 500 ppm of indium, and, for example, a powder of zinc alloy which contains 5 to 100 ppm of aluminum and calcium, 50 to 5000 ppm of bismuth, and 100 to 5000 ppm of indium, or the like.

As the separator, it is possible to use, for example, a non-woven fabric which mainly contains a polyvinyl alcohol fiber and a rayon fiber. It is preferred that the thickness of the separator is set at 150 to 300 μm. If the thickness of the separator is 150 μm or more, it is possible to prevent the dendritic crystal of zinc oxide grown in the negative electrode from penetrating the separator. If the thickness of the separator is 300 μm or less, the increase in the internal resistance can be suppressed, so that the discharge performance can be more surely maintained.

Note that the thickness of the separator can be changed, for example, by adjusting the basis weight (fiber weight per unit area) of a fiber sheet constituting the separator, and by constituting the separator with a plurality of fiber sheets and adjusting the number of the laminated fiber sheets.

For the alkaline electrolytic solution, for example, a potassium hydroxide aqueous solution is used. As the alkaline electrolytic solution, it is preferred to use the potassium hydroxide aqueous solution having a concentration of 33 to 45% by weight. If the concentration of the potassium hydroxide aqueous solution is 33% by weight or more, the amount of potassium hydroxide is secured so as to prevent the passivation of the powder of zinc or zinc alloy due to the formation of zinc oxide crystals on the surface of the particles of zinc or zinc alloy, as a result of which the discharge performance can be surely maintained. On the other hand, if the concentration of the potassium hydroxide aqueous solution is 45% by weight or less, the growth of dendritic crystals of zinc oxide in the negative electrode can be suppressed, so that internal short circuits can be prevented.

### EXAMPLES

In the following, examples according to aspects of the invention will be described in detail, but the invention is not limited to the examples.

### Experimental Example 1

(1) Production of Electrolytic Manganese Dioxide Powder

An electrolysis was performed at a current density of 1.0 A/dm² by heating an electrolytic cell containing a manganese sulfate solution at 90° C. or more, so that a deposit was obtained by making electrolytic manganese dioxide deposited on the anode. A plate-shaped electrode made of titanium was used for the anode, while a plate-shaped electrode made of graphite was used for the cathode. The deposit formed on the anode was peeled and coarsely crushed. The crushed deposit washed with water and dried, and thereafter finely ground to a predetermined particle size by a roller mill, so that an electrolytic manganese dioxide powder was obtained.

Thereafter, the electrolytic manganese dioxide powder was cleaned and neutralized in order to remove the sulfuric acid remaining in the electrolytic manganese dioxide powder, and then dried so that an electrolytic manganese dioxide powder used for the positive electrode active material was obtained. The average particle diameter of the obtained electrolytic manganese dioxide powder was 40 μm. In the neutralization process, a sodium hydroxide aqueous solution was used as the neutralizing agent. At this time, the concentration of the sodium hydroxide aqueous solution was adjusted so that the sodium content per 100 parts by weight of the electrolytic manganese dioxide powder in the positive electrode mixture was set to 0.3 parts by weight.

(2) Production of Positive Electrode Mixture

The electrolytic manganese dioxide powder obtained as described above, a silicon powder having an average particle diameter of 10 μm, a graphite powder having an average particle diameter of 15 μm as the conductive agent, a potassium hydroxide aqueous solution having a concentration of 36% by weight as the alkaline electrolytic solution, were mixed. At this time, the weight ratio of the electrolytic manganese dioxide powder: the graphite powder: the potassium hydroxide aqueous solution was adjusted to 93.5:5.0:1.5. The obtained mixture was uniformly stirred and mixed by a mixer so as to have a uniform particle size. The obtained particulate material was subjected to pressure molding to be formed into a hollow cylindrical shape, so that a positive electrode mixture pellet was obtained.

(3) Production of Alkaline Battery

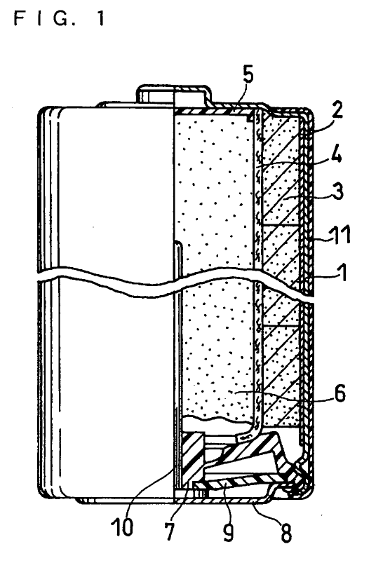

An AA size alkaline battery was produced as follows, by using the positive electrode mixture obtained as described above. FIG. 1 is a partial sectional front view of an alkaline primary battery of an example according to an aspect of the invention.

A bottomed cylindrical positive electrode case 1 having a graphite coating film 2 formed on its inner surface and made of a nickel plated steel plate, was prepared. A plurality of positive electrode mixture pellets 3 were inserted into the positive electrode case 1, and thereafter re-pressurized in the positive electrode case 1, so that the positive electrode mixture pellets 3 were brought into close contact with the inner surface of the positive electrode case 1. Typically, the AA size battery comprises four positive electrode mixture pellets that each weigh about 2.13 grams, for a total weight of the positive electrode mixture of about 8.52 grams. Then, a separator 4 having a thickness of 250 μm and an insulation cap 5 were arranged inside the positive electrode mixture pellets 3. Thereafter, a potassium hydroxide aqueous solution having a concentration of 36% by weight, as the electrolytic solution, was poured in order to wet the separator 4 and the positive electrode mixture pellets 3. A non-woven fabric which mainly contains a polyvinyl alcohol fiber and a rayon fiber was used for the separator 4.

After the potassium hydroxide aqueous solution was poured, a gel negative electrode 6 was filled inside the separator 4. For the gel negative electrode 6, a mixture obtained by mixing sodium polyacrylate as the gelling agent, the potassium hydroxide aqueous solution having the concentration of 36% by weight as the alkaline electrolytic solution, and a negative electrode active material in weight ratio of (1:33:66), was used. For the negative electrode active material, a powder (having a median diameter of 237 μm) of zinc alloy containing 30 ppm of aluminum, 200 ppm of bismuth, and 500 ppm of indium, was used.

A negative electrode current collector 10 formed by integrating a resin sealing plate 7, a bottom plate 8 serving as a negative electrode terminal, and an insulation washer 9, was prepared. The negative electrode current collector 10 was inserted into the gel negative electrode 6. The opening of the positive electrode case 1 was sealed by caulking the opening end of the positive electrode case 1 to the peripheral edge of the bottom plate 8 via the end of the sealing plate 7. Then, an outer label 11 was stuck to the outer surface of the positive electrode case 1.

At the time of producing the above described alkaline battery, alkaline batteries 1 to 9 were produced, respectively, by variously changing the content of sodium and silicon powders in the positive electrode mixture as shown in Table 1. Note that the silicon content in Table 1 to 3 represents the amount per 100 parts by weight of the electrolytic manganese dioxide.

Evaluation Test

The discharge tests for the batteries 1 to 9 were carried out by the following procedures.

Five batteries were prepared for each type of the batteries of No. 1 to 9. Each battery and a resistor of 3.3 ohm were connected in series, so that a cycle of discharging for 4 minutes under the load of 3.3Ω per a battery and then ceasing for 56 minutes was repeated eight times in an environment at 20° C. The batteries were subsequently allowed to stand for 16 hours at open circuit and the above cycle was repeated. The discharge time for the closed circuit voltage to reach 0.9 V was investigated for each battery.

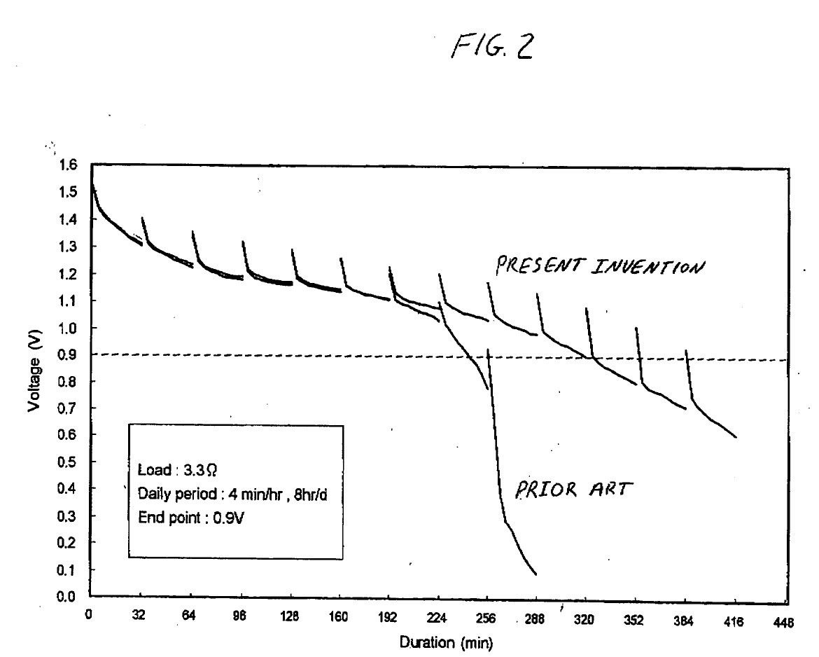

As shown in FIG. 2, batteries according to the present invention, were discharged at least 270 minutes at a closed circuit voltage of greater than 0.9 V, when discharged according to the above-described discharge regimen of cycling a 3.3Ω load. The closed circuit voltage of prior art batteries, on the other hand, fall below 0.9 V in less than 270 minutes of discharge. In certain embodiments of the present invention, the batteries can be discharged at least 300 minutes and up to about 320 minutes at a closed circuit voltage of greater than 0.9 V, when discharged according to the above-described discharge regimen of cycling a 3.3Ω load.

Batteries according to an aspect of the invention have higher positive electrode mixture capacity than prior art batteries. AA size batteries according to an aspect of the invention have a capacity above 0.9 V closed circuit voltage of at least 0.20 Ahr/g when discharged according to the above-described discharge regimen of cycling a 3.3Ω load. In certain embodiments of the invention, AA size batteries have a capacity above 0.9 V closed circuit voltage of at least 0.22 Ahr/g of positive electrode mixture.

The capacity of the battery was calculated by determining the average voltage during each cycle of discharge testing and dividing the average voltage by the 3.3 ohm load and multiplying the current by the 32 minutes of discharge. Then the capacity from each discharge cycle was added, and the total capacity was divided by the positive electrode mixture weight of 8.52 grams.

AA size alkaline batteries according to another aspect of the invention have a capacity above 0.9 V closed circuit voltage of at least 37.7 min/g of electrolytic manganese dioxide when discharged according to the above-described discharge regimen of cycling a 3.3Ω load.

Further, a reference value of the discharge time was set to 300 minutes, and the number of abnormally discharged batteries was investigated by making a battery having the discharge time shorter than 90% of the reference value determined to have abnormally discharged. When the abnormally discharged batteries were disassembled, it was confirmed that in each of the batteries, the dendritic crystal of zinc oxide grown in the negative electrode penetrated the separator to reach the positive electrode, so as to cause the internal short circuit.

The results of the above described evaluation tests are shown in Tables 1 to 3. Note that the discharge capacity shown in Table 1 to 3 represents an average value of each set of the five batteries. In addition, the discharge capacity is expressed as the index obtained by setting the discharge capacity of battery 8 to 100.

TABLE 1

| | | | MEDIAN | | |
|---|---|---|---|---|---|
| | SILICON | SODIUM | DIAMETER | | |
| | CONTENT | CONTENT | OF ZINC | THE NUMBER | |
| | IN | IN | ALLOY | OF | |
| | POSITIVE | POSITIVE | POWDER IN | BATTERIES | |
| | ELECTRODE | ELECTRODE | NEGATIVE | ABNORMALLY | DISCHARGE |
| BATTERY | (PARTS BY | (PARTS BY | ELECTRODE | DISCHARGED | CAPACITY |
| No. | WEIGHT) | WEIGHT) | (μm) | (NUMBER) | (INDEX) |
| 1 | 0.003 | 0.3 | 237 | 3 | 78 |
| 2 | 0.004 | 0.3 | 237 | 1 | 88 |
| 3 | 0.005 | 0.3 | 237 | 0 | 105 |
| 4 | 0.01 | 0.3 | 237 | 0 | 106 |
| 5 | 0.02 | 0.3 | 237 | 0 | 107 |
| 6 | 0.03 | 0.3 | 237 | 0 | 103 |
| 7 | 0.04 | 0.3 | 237 | 0 | 101 |
| 8 | 0.05 | 0.3 | 237 | 0 | 100 |
| 9 | 0.06 | 0.3 | 237 | 0 | 92 |

From Table 1, it can be seen that in each of the batteries 3 to 8 having the silicon content of 0.005 to 0.05 parts by weight per 100 parts by weight of electrolytic manganese dioxide in the positive electrode, excellent discharge performance was obtained without the occurrence of abnormal discharge due to the internal short circuit. Further, in the batteries 1 and 2 having the silicon content of less than 0.005 parts by weight per 100 parts by weight of electrolytic manganese dioxide in the positive electrode, the occurrence of abnormal discharge due to internal short circuits was observed. Further, in the battery 9 having the silicon content of more than 0.05 parts by weight per 100 parts by weight of electrolytic manganese dioxide in the positive electrode, the discharge performance was deteriorated.

### Experimental Example 2

Alkaline batteries 10 to 17 were produced similarly to the test example 1, except that the silicon content in the positive electrode was changed to 0.02 parts by weight per 100 parts by weight of electrolytic manganese dioxide, and that the sodium content in the positive electrode was variously changed as shown in Table 2, and were evaluated. Note that the sodium content in Table 2 represents the amount of sodium per 100 parts by weight of electrolytic manganese dioxide. The sodium content in the positive electrode was adjusted by changing the concentration of the sodium hydroxide aqueous solution used as the neutralizing agent and the neutralization time in the neutralization process.

The evaluation result is shown in Table 2 along with the result of the battery 5. Note that the discharge capacity in Table 2 is expressed as the index obtained by setting the discharge capacity of battery 14 to 100.

TABLE 2

| | | | MEDIAN | | |
|---|---|---|---|---|---|
| | SILICON | SODIUM | DIAMETER | | |
| | CONTENT | CONTENT | OF ZINC | THE NUMBER | |
| | IN | IN | ALLOY | OF | |
| | POSITIVE | POSITIVE | POWDER IN | BATTERIES | |
| | ELECTRODE | ELECTRODE | NEGATIVE | ABNORMALLY | DISCHARGE |
| BATTERY | (PARTS BY | (PARTS BY | ELECTRODE | DISCHARGED | CAPACITY |
| No. | WEIGHT) | WEIGHT) | (μm) | (NUMBER) | (INDEX) |
| 10 | 0.02 | 0.05 | 237 | 0 | 111 |
| 11 | 0.02 | 0.1 | 237 | 0 | 110 |
| 12 | 0.02 | 0.2 | 237 | 0 | 109 |
| 5 | 0.02 | 0.3 | 237 | 0 | 107 |
| 13 | 0.02 | 0.5 | 237 | 0 | 103 |
| 14 | 0.02 | 0.7 | 237 | 0 | 100 |
| 15 | 0.02 | 0.8 | 237 | 1 | 80 |
| 16 | 0.02 | 0.9 | 237 | 3 | 75 |
| 17 | 0.02 | 1.0 | 237 | 5 | 42 |

In each of batteries 5 and 11 to 14, having a sodium content of 0.1 to 0.7 parts by weight per 100 parts by weight of electrolytic manganese dioxide in the positive electrode, excellent discharge performance was obtained without the occurrence of abnormal discharge due to internal short circuits. In battery 10 having a sodium content less than 0.1 parts by weight per 100 parts by weight of electrolytic manganese dioxide in the positive electrode, excellent discharge performance was also obtained without the occurrence of abnormal discharge due to internal short circuits. However, in battery 10, because of the electrolytic manganese dioxide having a low pH, the metal mold for molding the positive electrode mixture was corroded at the time of producing the battery, causing a trouble in the manufacturing process. Further, in batteries 15 to 17 having sodium contents of more than 0.7 parts by weight per 100 parts by weight of electrolytic manganese dioxide in the positive electrode, the amount of sodium was excessively increased, so that the occurrence of abnormal discharge due to the internal short circuit was observed.

### Experimental Example 3

Alkaline batteries 18 to 22 were produced similarly to the test example 1, except that the silicon content in the positive electrode was set to 0.02 parts by weight per 100 parts by weight of electrolytic manganese dioxide, and that the thickness of the separator was variously changed as shown in Table 3, and were evaluated. Note that in the case of the thickness of the separator of 120 to 150 μm, the thickness was adjusted by adjusting the basis weight (fiber weight per unit area) of the fiber sheet. In the case of the thickness of the separator of more than 150 μm, the thickness was adjusted by laminating the plurality of fiber sheets.

The evaluation result is shown in Table 3 along with the result of battery 5. Note that the discharge capacity in Table 3 is expressed as the index obtained by setting the discharge capacity of battery 21 to 100.

TABLE 3

| | | | MEDIAN | | | |
|---|---|---|---|---|---|---|
| | SILICON | SODIUM | DIAMETER | | | |
| | CONTENT | CONTENT | OF ZINC | | THE NUMBER | |
| | IN | IN | ALLOY | | OF | |
| | POSITIVE | POSITIVE | POWDER IN | THICKNESS | BATTERIES | |
| | ELECTRODE | ELECTRODE | NEGATIVE | OF | ABNORMALLY | DISCHARGE |
| BATTERY | (PARTS BY | (PARTS BY | ELECTRODE | SEPARATOR | DISCHARGED | CAPACITY |
| No. | WEIGHT) | WEIGHT) | (μm) | (μm) | (NUMBER) | (INDEX) |
| 18 | 0.02 | 0.3 | 237 | 120 | 5 | 65 |
| 19 | 0.02 | 0.3 | 237 | 140 | 2 | 80 |
| 20 | 0.02 | 0.3 | 237 | 150 | 0 | 115 |
| 5 | 0.02 | 0.3 | 237 | 250 | 0 | 105 |
| 21 | 0.02 | 0.3 | 237 | 300 | 0 | 100 |
| 22 | 0.02 | 0.3 | 237 | 320 | 0 | 90 |

In each of batteries 5, 20 and 21, having a separator thickness of 150 to 300 μm, excellent discharge performance was obtained without the occurrence of abnormal discharge due to internal short circuits. In batteries 18 and 19, having a separator thickness of less than 150 μm, the occurrence of abnormal discharge due to internal short circuits was observed. In battery 22 having a separator thickness of more than 300 μm, the discharge performance was deteriorated due to the increase in the internal resistance.

### Experimental Example 4

Alkaline batteries 23 to 27 were produced similarly to the test example 1, except that the silicon content in the positive electrode was set to 0.02 parts by weight per 100 parts by weight of electrolytic manganese dioxide, and that the concentration of the potassium hydroxide aqueous solution used for the electrolytic solution was variously changed as shown in Table 4, and were evaluated.

The evaluation result is shown in Table 4 along with the result of the battery 5. Note that the discharge capacity in Table 4 is expressed as the index obtained by setting the discharge capacity of the battery 26 to 100.

TABLE 4

| | | | MEDIAN | | | |
|---|---|---|---|---|---|---|
| | SILICON | SODIUM | DIAMETER | | | |
| | CONTENT | CONTENT | OF ZINC | | THE NUMBER | |
| | IN | IN | ALLOY | CONCENTRATION | OF | |
| | POSITIVE | POSITIVE | POWDER IN | OF | BATTERIES | |
| | ELECTRODE | ELECTRODE | NEGATIVE | ELECTROLYTIC | ABNORMALLY | DISCHARGE |
| BATTERY | (PARTS BY | (PARTS BY | ELECTRODE | SOLUTION | DISCHARGED | CAPACITY |
| No. | WEIGHT) | WEIGHT) | (μm) | (% BY WEIGHT) | (NUMBER) | (INDEX) |
| 23 | 0.02 | 0.3 | 237 | 30 | 0 | 93 |
| 24 | 0.02 | 0.3 | 237 | 33 | 0 | 106 |
| 25 | 0.02 | 0.3 | 237 | 36 | 0 | 115 |
| 5 | 0.02 | 0.3 | 237 | 40 | 0 | 105 |
| 26 | 0.02 | 0.3 | 237 | 45 | 0 | 100 |
| 27 | 0.02 | 0.3 | 237 | 48 | 1 | 89 |

In each of batteries 24 to 26, having a concentration of the electrolytic solution of 33 to 45% by weight, excellent discharge performance was obtained without the occurrence of abnormal discharge due to internal short circuits. In battery 23 having a concentration of the electrolytic solution of less than 33% by weight, the discharge performance was deteriorated. In battery 27 having the concentration of the electrolytic solution of more than 45% by weight, the occurrence of abnormal discharge due to internal short circuits was observed, and the discharge performance was deteriorated.

### Experimental Example 5

Alkaline batteries 28 to 32 were produced similarly to the test example 1, except that the silicon content in the positive electrode was set to 0.004 parts by weight per 100 parts by weight of electrolytic manganese dioxide, and that the median diameter of zinc alloy powder was set as shown in Table 5, and were evaluated. The evaluation result is shown in Table 5 along with the result of the battery 2.

TABLE 5

| | | | MEDIAN | | |
|---|---|---|---|---|---|
| | SILICON | SODIUM | DIAMETER | | |
| | CONTENT | CONTENT | OF ZINC | THE NUMBER | |
| | IN | IN | ALLOY | OF | |
| | POSITIVE | POSITIVE | POWDER IN | BATTERIES | |
| | ELECTRODE | ELECTRODE | NEGATIVE | ABNORMALLY | DISCHARGE |
| BATTERY | (PARTS BY | (PARTS BY | ELECTRODE | DISCHARGED | CAPACITY |
| No. | WEIGHT) | WEIGHT) | (μm) | (NUMBER) | (INDEX) |
| 28 | 0.004 | 0.3 | 110 | 0 | 104 |
| 29 | 0.004 | 0.3 | 136 | 0 | 102 |
| 30 | 0.004 | 0.3 | 168 | 0 | 103 |
| 31 | 0.004 | 0.3 | 200 | 0 | 100 |
| 32 | 0.004 | 0.3 | 219 | 0 | 105 |
| 2 | 0.004 | 0.3 | 237 | 1 | 88 |

### Experimental Example 6

Alkaline batteries 33 to 37 were produced similarly to the test example 1, except that the silicon content in the positive electrode was set to 0.003 parts by weight per 100 parts by weight of electrolytic manganese dioxide, and that the median diameter of zinc alloy powder was set as shown in Table 6, and were evaluated. The evaluation result is shown in Table 6 along with the result of the battery 1.

TABLE 6

| | | | MEDIAN | | |
|---|---|---|---|---|---|
| | SILICON | SODIUM | DIAMETER | | |
| | CONTENT | CONTENT | OF ZINC | THE NUMBER | |
| | IN | IN | ALLOY | OF | |
| | POSITIVE | POSITIVE | POWDER IN | BATTERIES | |
| | ELECTRODE | ELECTRODE | NEGATIVE | ABNORMALLY | DISCHARGE |
| BATTERY | (PARTS BY | (PARTS BY | ELECTRODE | DISCHARGED | CAPACITY |
| No. | WEIGHT) | WEIGHT) | (μm) | (NUMBER) | (INDEX) |
| 33 | 0.003 | 0.3 | 110 | 0 | 104 |
| 34 | 0.003 | 0.3 | 136 | 0 | 101 |
| 35 | 0.003 | 0.3 | 168 | 0 | 102 |
| 36 | 0.003 | 0.3 | 200 | 0 | 101 |
| 37 | 0.003 | 0.3 | 219 | 1 | 89 |
| 1 | 0.003 | 0.3 | 237 | 3 | 78 |

From Tables 5 and 6, it can be seen that even in the case where the silicon contents in the positive electrode are 0.004 parts by weight and 0.003 parts by weight, the median diameter of zinc alloy powder ranging from 110 to 200 μm is preferred.

The alkaline battery according to an aspect of the invention is capable of suppressing internal short circuits due to the growth of the dendritic crystal of zinc oxide, and is excellent in reliability, even in the case where the amount of sodium remaining in the electrolytic manganese dioxide powder used for the positive electrode active material is large. Therefore, the alkaline battery according to an aspect of the invention can be used as a power supply for electronic devices, such as a communication device and a portable device.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline battery having: a positive electrode comprising electrolytic manganese dioxide; a negative electrode comprising zinc or a zinc alloy; a separator arranged between the positive electrode and the negative electrode; and an alkaline electrolytic solution,
wherein the positive electrode comprises 0.1 to 0.7 parts by weight of sodium per 100 parts by weight of electrolytic manganese dioxide, and 0.003 to 0.05 parts by weight of silicon per 100 parts by weight of electrolytic manganese dioxide.

2. The alkaline battery according to claim 1, wherein the thickness of the separator is 150 to 300 μm.

3. The alkaline battery according to claim 1, wherein the alkaline electrolytic solution is a potassium hydroxide aqueous solution having a concentration of 33 to 40% by weight.

4. The alkaline battery according to claim 1, wherein the zinc or the zinc alloy is provided in powder form having a median diameter of 110 to 200 μm.

5. The alkaline battery according to claim 1, wherein the positive electrode comprises 0.005 to 0.05 parts by weight of silicon per 100 parts by weight of electrolytic manganese dioxide.

6. An AA size alkaline battery having: a positive electrode comprising a positive electrode mixture comprising electrolytic manganese dioxide; a negative electrode comprising zinc or a zinc alloy; a separator arranged between the positive electrode and the negative electrode; and an alkaline electrolytic solution, wherein the battery has a capacity above 0.9 V closed circuit voltage of at least 0.20 Ahr/g of positive electrode mixture when the battery is subjected to a sequential discharge regimen at 20° C. as follows:
a) discharge under a 3.3Ω load for 4 minutes;
b) disconnect the load for 56 minutes;
c) repeat a) and b) for an additional 7 cycles;
d) stand at open circuit for 16 hours; and
e) repeat a) through d).

7. The AA size alkaline battery according to claim 6, wherein the battery has a capacity above 0.9 V closed circuit voltage of at least 0.22 Ahr/g of positive electrode mixture.

8. The AA size alkaline battery according to claim 6, wherein the capacity was calculated by determining the average voltage during each cycle of discharge testing and dividing the average voltage by the 3.3 ohm load and multiplying the current by the 32 minutes of discharge, and then adding the capacity from each discharge cycle, and dividing the total capacity by the positive electrode mixture weight of 8.52 grams.

9. An AA size alkaline battery having:
a positive electrode comprising a positive electrode mixture comprising electrolytic manganese dioxide;
a negative electrode comprising zinc or a zinc alloy;
a separator arranged between the positive electrode and the negative electrode; and an alkaline electrolytic solution, wherein the battery has a capacity above 0.9 V closed circuit voltage of at least 37.7 min/g of electrolytic manganese dioxide when the battery is subjected to a sequential discharge regimen at 20° C. as follows:
a) discharge under a 3.3Ω load for 4 minutes;
b) disconnect the load for 56 minutes;
c) repeat a) and b) for an additional 7 cycles;
d) stand at open circuit for 16 hours; and
e) repeat a) through d).
